(19) United States
(12) Patent Application Publication
(10) Pub. No.: US 2016/0176757 A1
(43) Pub. Date: Jun. 23, 2016

(54) CEMENT COMPOSITIONS FOR WELLBORE CEMENTING OPERATION

(71) Applicant: Trican Well Service Ltd., Calgary (CA)

(72) Inventors: Karen LUKE, Calgary (CA); Kung Pok CHAN, Calgary (CA)

(21) Appl. No.: 14/974,337

(22) Filed: Dec. 18, 2015

Related U.S. Application Data
(60) Provisional application No. 62/096,159, filed on Dec. 23, 2014.

(51) Int. Cl. C04B 22/00; C04B 7/02; C09K 8/46; C04B 24/30

(52) U.S. Cl. CPC C04B 22/0086; C04B 24/30; C04B 7/02; C09K 8/46

(57) ABSTRACT

Cement composition suitable for cementing a well, and method of preparing the cement composition is disclosed. The cement composition comprises cement, water and a seeding additive for forming seeding sites distributed generally homogeneously in the cement composition for promoting growth of fibrous Type I calcium silicate hydrate (C-S-H) binders throughout. The seeding additive may be solid-form fibrous material having charged surface, or may alternatively be liquid-form resin mixed with a suitable hardening agent.

### CROSS-REFERENCE TO RELATED APPLICATIONS

This application claims the benefit of U.S. Provisional Patent Application Ser. No. 62/096,159, filed Dec. 23, 2014, the entirety of which is incorporated herein by reference.

### FIELD OF THE DISCLOSURE

The embodiments generally relate to cement compositions suitable for cementing a well and methods of preparing the cement compositions, and more particularly, to cement compositions forming fibrous Type I calcium silicate hydrate (C-S-H) binders in-situ and methods of preparing same for use in cementing oil and gas wells.

### BACKGROUND OF THE DISCLOSURE

In the oil and gas industry, cementing of tubulars, such as casing or liners, in a wellbore is one of the most important operations performed on wells in order to ensure complete zonal isolation and aquifer protection in the formation thereabout. Without cementing, an effective well may never reach its full production potential, and liquids from one zone could interfere with another.

After drilling a well, casing is run into the wellbore. Cement slurry is prepared and pumped down the wellbore and upwards into an annulus between the casing and the formation, filling the annular space. Depending on the application, all or a portion of the annulus to a depth of the wellbore is filled with cement slurry. After the cement slurry sets in the annular space, the hardened cement forms therein an annular cement sheath, which provides annular isolation between zones in the formation, thereby preventing cross contamination. The cement sheath further supports the weight of the column of casing in the wellbore, and protects the casing from corrosion and collapse.

The cement sheath is subjected to stresses, such as stresses caused during the well completion processes as a result of pressure testing, cyclic thermal expansion during fracturing, and repeated drill bit impact and external formation forces. As the cement sheath is inherently brittle in nature, stresses may undermine the integrity of the cement sheath over time, resulting in a loss of integrity, such as in the form of micro-cracks therein. Consequently, the cement sheath may lose its ability to maintain zonal isolation, resulting in potential failure of the cement sheath and annular fluid migration between the casing and cement, or along the cement/formation interface.

Existing approaches for preventing disruption of the cement sheath aim to make the cement sheath more flexible and resistant to stresses by reinforcing the cement sheath with fibers and/or elastomeric material, and/or by foaming of the cement.

For example, U.S. Pat. No. 6,907,929 to Leroy-Delage, et al., discloses cementing compositions for oil wells or the like comprising between 30% and 100% by weight of the cement (bwoc) of rubber particles, having a grain size in the 40-60 mesh range, for producing a low density slurry while keeping the cement permeability low. Such compositions are purported to be particularly advantageous for cementing zones subjected to extreme dynamic stresses such as perforation zones and the junctions of branches in a multi-sidetrack well.

U.S. Pat. No. 8,123,852 to Reddy, et al., discloses cement compositions that include high aspect ratio materials, such as melt-processed inorganic fibers, and methods for using such cement compositions in subterranean formations.

U.S. Pat. No. 7,913,757 to Reddy, et al, teaches a method of cementing a wellbore in a subterranean formation, comprising formulating a cement composition that may be suitable for long-term zonal isolation of the subterranean formation by evaluating a subterranean formation, preparing a base cement composition, determining the compressive strength of the base cement composition, determining the tensile strength of the base cement composition, and adjusting the ratio of compressive strength to tensile strength as needed to within a first optimizing range by adding plastic, carbon or glass fibers or combinations thereof to form a first optimized cement composition, and placing the optimized cement composition in the wellbore.

However, there continues to exist the desire of further improving the ability of the cement sheath to resist stresses which may adversely affect cement integrity.

### SUMMARY OF THE DISCLOSURE

According to one aspect of this disclosure, there is disclosed a method for promoting growth of fibrous calcium silicate hydrates (C-S-H) binders throughout a wellbore cementing composition. The method comprises: combining cement, water and a seeding additive, the seeding additive having a charged surface; and mixing said combination of the cement, water and seeding additive to form a seeded slurry with the seeding additive distributed homogeneously therein.

In one embodiment, the seeding additive is solid-form fiber-seeds.

In another embodiment, the fiber-seeds have a shape at least a portion of which is a fiber-like shape.

In another embodiment, the at least a portion of the shape has an average aspect ratio between about 2 and about 200.

In another embodiment, the at least a portion of the shape has an average aspect ratio of about 10.

In another embodiment, the at least a portion of the shape has an average length comparable to the average length of fibrous Type I C-S-H binders.

In another embodiment, the at least a portion of the shape has an average length no longer than about 50 microns.

In another embodiment, the at least a portion of the shape has an average length no longer than about 10 microns.

In another embodiment, the at least a portion of the shape has an average length no longer than about 5 microns.

In another embodiment, the fiber-seeds comprise inorganic fibers having a charged surface.

In another embodiment, the fiber-seeds comprise at least one of single chain inosilicates and double chain inosilicates.

In another embodiment, the fiber-seeds comprise pectolite, hillebrandite, okenite, wollastonite, horneblende, xonotlite, tobermorite, jennite, foshagite, or a combination thereof.

In another embodiment, the fiber-seeds comprise pure silica, potassium titanate, aluminum borosilicate, aluminum oxide-zirconium oxide polymer, aluminosilicate fiber, serpentine, amphibole, or a combination thereof.

In another embodiment, the fiber-seeds comprise glass fibers.

In another embodiment, the seeding additive comprises an organic composition.

In another embodiment, the seeding additive comprises resin in a hardened form.

In another embodiment, said resin has irregular shape.

In another embodiment, said resin has a shape at least a portion of which is a fiber-like shape.

In another embodiment, the at least a portion of the shape has an average aspect ratio between about 2 and about 200.

In another embodiment, the at least a portion of the shape has an average aspect ratio of about 10.

In another embodiment, the at least a portion of the shape has an average length comparable to the average length of fibrous Type I C-S-H binders.

In another embodiment, the at least a portion of the shape has an average length no longer than about 50 microns.

In another embodiment, the at least a portion of the shape has an average length no longer than about 10 microns.

In another embodiment, the at least a portion of the shape has an average length no longer than about 5 microns.

In another embodiment, the amount of the seeding additive is no more than about 10% by weight of the cement (bwoc).

In another embodiment, the amount of the seeding additive is in the range of between about 0.5% bwoc and about 10% bwoc.

In another embodiment, the amount of the seeding additive is about 1% bwoc.

In another embodiment, the amount of the seeding additive is about 5% bwoc.

In another embodiment, the seeding additive comprises resin in a liquid form.

In another embodiment, said combining of the cement, water and the seeding additive to form the seeded slurry comprises: mixing cement and water to form a non-seeded slurry; and adding the resin in a liquid form to the non-seeded slurry to form the seeded slurry.

In another embodiment, the non-seeded slurry and the resin in a liquid form are mixed in a volume ratio of about 3:1.

In another embodiment, said resin is phenolic resin, acrylic resin, epoxy resin, styrene-vinyl ester, or a combination thereof.

According to another aspect of this disclosure, there is disclosed a seeded slurry for cementing a wellbore. The seeded slurry comprises: cement; water; and a seeding additive having a charged surface, the seeding additive distributed homogeneously in the seeded slurry for promoting growth of fibrous C-S-H binders throughout the seeded slurry.

In one embodiment, the seeding additive is solid-form fiber-seeds.

In another embodiment, the fiber-seeds have a shape at least a portion of which is a fiber-like shape.

In another embodiment, the at least a portion of the shape has an average aspect ratio between about 2 and about 200.

In another embodiment, the at least a portion of the shape has an average aspect ratio of about 10.

In another embodiment, the at least a portion of the shape has an average length comparable to the average length of fibrous Type I C-S-H binders.

In another embodiment, the at least a portion of the shape has an average length no longer than about 50 microns.

In another embodiment, the at least a portion of the shape has an average length no longer than about 10 microns.

In another embodiment, the at least a portion of the shape has an average length no longer than about 5 microns.

In another embodiment, the fiber-seeds comprise inorganic fibers having a charged surface.

In another embodiment, the fiber-seeds comprise at least one of single chain inosilicates and double chain inosilicates.

In another embodiment, the fiber-seeds comprise pectolite, hillebrandite, okenite, wollastonite, horneblende, xonotlite, tobermorite, jennite, foshagite, or a combination thereof.

In another embodiment, the fiber-seeds comprise pure silica, potassium titanate, aluminum borosilicate, aluminum oxide-zirconium oxide polymer, aluminosilicate fiber, serpentine, amphibole, or a combination thereof.

In another embodiment, the fiber-seeds comprise glass fibers.

In another embodiment, the seeding additive comprises an organic composition.

In another embodiment, the seeding additive comprises resin in a hardened form.

In another embodiment, said resin has irregular shape.

In another embodiment, said resin has a shape at least a portion of which is a fiber-like shape.

In another embodiment, the at least a portion of the shape has an average aspect ratio between about 2 and about 200.

In another embodiment, the at least a portion of the shape has an average aspect ratio of about 10.

In another embodiment, the at least a portion of the shape has an average length comparable to the average length of fibrous Type I C-S-H binders.

In another embodiment, the at least a portion of the shape has an average length no longer than about 50 microns.

In another embodiment, the at least a portion of the shape has an average length no longer than about 10 microns.

In another embodiment, the at least a portion of the shape has an average length no longer than about 5 microns.

In another embodiment, the amount of the seeding additive is no more than about 10% bwoc.

In another embodiment, the amount of the seeding additive is in the range of between about 0.5% bwoc and about 10% bwoc.

In another embodiment, the amount of the seeding additive is about 1% bwoc.

In another embodiment, the amount of the seeding additive is about 5% bwoc.

In another embodiment, the seeding additive comprises resin in a liquid form.

In another embodiment, said seeded slurry is formed by: mixing cement and water to form a non-seeded slurry; and adding the resin in a liquid form to the non-seeded slurry to form the seeded slurry.

In another embodiment, the non-seeded slurry and the resin in a liquid form are mixed in a volume ratio of about 3:1.

In another embodiment, said resin is phenolic resin, acrylic resin, epoxy resin, styrene-vinyl ester, or a combination thereof.

According to another aspect of this disclosure, there is disclosed a method of cementing a well. The method comprises: preparing a pumpable slurry; and pumping the slurry into the well; wherein the pumpable slurry comprises: cement; water; and a seeding additive having a charged surface and distributed homogeneously in said slurry for promoting growth of fibrous C-S-H throughout the slurry.

According to another aspect of this disclosure, there is disclosed a method of cementing a well. The method comprises: preparing a pumpable slurry; and pumping the slurry into the well; wherein the pumpable slurry comprises: cement; water; and resin in a liquid form premixed with a hardening agent, wherein said resin is a seeding additive having a charged surface and distributed homogeneously in said slurry for promoting growth of fibrous C-S-H throughout the slurry.

According to another aspect of this disclosure, there is disclosed a cement mixture for cementing a wellbore. The cement mixture comprises: cement; and a seeding additive having a charged surface homogeneously distributed in the cement, the seeding additive promoting the growth of fibrous C-S-H binders when the cement mixture is mixed with water.

In one embodiment, the seeding additive is solid-form fiber-seeds.

In another embodiment, the fiber-seeds have a shape at least a portion of which is a fiber-like shape.

In another embodiment, the fiber-seeds comprise inorganic fibers having a charged surface.

In another embodiment, the seeding additive comprises an organic composition.

In another embodiment, the seeding additive comprises resin in a hardened form.

In another embodiment, the seeding additive comprises resin in a liquid form.

In another embodiment, said resin is phenolic resin, acrylic resin, epoxy resin, styrene-vinyl ester, or a combination thereof.

According to another aspect of this disclosure, there is disclosed a cement composition comprising: fibrous C-S-H binders homogeneously distributed in the cement composition; wherein at least a portion of the fibrous C-S-H binders are grown from a seeding additive having a charged surface.

### BRIEF DESCRIPTION OF THE DRAWINGS

FIG. 1 is a Scanning Electron Microscope (SEM) image at the 300 μm magnification level of xonotlite particles P, which are used as fiber-seeds in some examples disclosed herein, captured by a JEOL JSM-6610 SEM;

FIG. 2 is an SEM image at the 10 μm magnification level of the xonotlite particles of FIG. 1, which comprise fiber-seeds S;

FIG. 3 shows an SEM image at the 5 μm magnification level of a first sample of cement having no additive, and showing featureless Type IV C-S-H binders L;

FIG. 4 shows an SEM image at the 5 μm magnification level of a second sample of cement with addition of carbon nano-tubes, showing featureless Type IV C-S-H binders L, and no fibrous Type I C-S-H therein;

FIG. 5 shows an SEM image at the 5 μm magnification level of a third sample of cement using xonotlite as fiber-seeds, showing fibrous Type I C-S-H binders F formed therein;

FIG. 6 shows an SEM image at the 20 μm magnification level of a sample of cement with addition of xonotlite as fiber-seeds and fibrous Type I C-S-H binders F formed therein;

FIG. 7 shows an SEM image at the 5 μm magnification level of the sample of FIG. 6, showing fibrous Type I C-S-H binders F formed therein;

FIG. 8 is an SEM image at the 20 μm magnification level of a sample of cement with addition of wollastonite as fiber-seeds and fibrous Type I C-S-H binders F formed therein;

FIG. 9 shows an SEM image at the 5 μm magnification level of the sample of FIG. 8, showing fibrous Type I C-S-H binders F formed therein;

FIG. 10 shows an SEM image at the 50 μm magnification level of a sample of cement with resin fibers R and fibrous Type I C-S-H binders F formed therein according to an alternative embodiment disclosed herein;

FIGS. 11A and 11B show an SEM image at the 50 μm and 5 μm magnification levels, respectively, of resin particles Rs used as fiber-seeds; and

FIG. 12 shows an SEM image at the 5 μm magnification level of a sample of cement with addition of resin particles Rs of FIGS. 11A and 11B as fiber-seeds, and hardened-form resin R and fibrous Type I C-S-H binders F formed therein.

### DETAILED DESCRIPTION

Embodiments taught herein disclose cement compositions comprising fibrous calcium-silicate-hydrate (C-S-H) binders formed therein, and methods for forming fibrous Type I C-S-H binders in-situ. Each embodiment results in a seeded cement slurry generally comprising a cement, water and a seeding additive, which, when set, forms a cement sheath having a homogeneous matrix of fibrous Type I C-S-H binders therein that imparts improved tensile strength to the cement. Hereinafter, the terms “Type I C-S-H binders”, “fibrous Type I C-S-H binders” and “fibrous C-S-H binders” have the same meaning and are used interchangeably. The terms “seeded cement slurry” and “seeded slurry” have the same meanings, both referring to a cement slurry having a seeding additive, and are used interchangeably.

Any cement suitable for subterranean cementing can be used in the compositions and methods disclosed herein. For example, the cement may be a hydraulic cement, such as Portland cement, pozzolanic cements, gypsum cements, soil cements, silica cements, high alkalinity cements, or a combination thereof. In some embodiments, the cement can be any one or combination of class A, B, C, G, and H Portland cements as defined in API Specification 10A, entitled “Specification for Cements and Materials for Well Cementing”, twenty-fourth edition, published by the American Petroleum Institute (API) of Washington, D.C., USA, in December, 2010, the content of which is incorporated herein by reference in its entirety, or as defined in any other existing versions thereof.

In other embodiments, the cement can be a type of cement as defined in ISO 10426-1:2009, entitled “Petroleum and natural gas industries—Cements and materials for well cementing—Part 1: Specification,” developed by the International Organization for Standardization (ISO) of Geneva, Switzerland, the content of which is incorporated herein by reference in its entirety, or as defined in any other existing versions thereof.

In yet other embodiments, the cement can be Type I, IA, II(MH), II(MH)A, III, IIIA, IV, and V Portland cements as defined in ASTM C150/C150M-12, entitled “Standard Specification for Portland Cement”, published by ASTM International of West Conshohocken, Pa., USA, in April, 2012, the content of which is incorporated herein by reference in its entirety, or as defined in any other existing versions thereof.

The water used for making the cement slurry can be any suitable type of water conventionally used for making cement slurry for subterranean cementing, such as low mineral water, including tap water. However, those skilled in the art will appreciate that, other water, such as brine water, seawater or the like, can also be used.

As will be described in more detail below, the seeding additive may be solid-form inorganic or organic fiber-seeds, or may be liquid-form resin in various embodiments. When solid-form fiber-seeds are used, they may be supplied to users in dry form alone or mixed with cement, or as water mixture wherein solid-form fiber-seeds are pre-mixed with water and in suspension therein. When liquid-form resin is used as seeding additive, it is first mixed with a suitable hardening agent, and then the mixture may be added to cement slurry.

When mixed with cement slurry and/or water, the seeding additive forms a plurality of homogeneously-distributed seeding sites or locations in the cement slurry for promoting the growth of fibrous C-S-H binders therein. As a result, a large amount of fibrous C-S-H binders are formed and homogeneously or uniformly distributed in the set cement. The so-formed cement sheath exhibits improved mechanical properties as compared to a cement sheath without the seeding additive, and resists many stresses induced during well completion processes and otherwise over the lifetime of the well. In some embodiments, the so-formed cement composition comprises a predominant amount of fibrous C-S-H binders homogeneously distributed therein.

Cement Slurry Having Inorganic Fiber-Seeds

In some embodiments, the compositions are cement slurries generally comprising a cement, water and solid-form inorganic fiber-seeds as the seeding additive that forms fibrous C-S-H binders when setting. Herein, the inorganic fiber-seeds may be any suitable solid-form inorganic composition that, after mixing with cement and water, facilitates the growth of fibrous C-S-H binders, resulting in a homogeneous matrix of fibrous C-S-H binders in the cement when set.

Embodiments of the inorganic fiber-seeds disclosed herein generally have some common chemical and physical properties advantageous for facilitating the formation of fibrous C-S-H binders. Chemically, the inorganic fiber-seeds in some embodiments comprise materials having charged surfaces. Physically, the shape of the inorganic fiber-seeds, or at least a portion thereof, is preferably fiber-like, i.e., at least a portion of the inorganic fiber-seed body has a high aspect ratio. Herein, the term “aspect ratio” refers to the ratio of a solid body's length to its width. Further, the fiber-like portion of the inorganic fiber-seeds disclosed herein is generally of a length comparable to or shorter than a typical or average length of fibrous Type I C-S-H binders. The average length of fibrous Type I C-S-H binders is generally known in the art.

As a skilled person in the art would understand, in conventional cement compositions, when hydraulic cement, such as Portland cement, is mixed with water, C-S-H binders are formed as a result of the reaction between the silicate phases of the Portland cement and the water. Four types of C-S-H binders are typically formed, including Type I, which is an elongated fibrous material, Type II, which exhibits honeycombs or reticular networks, Type III, which is relatively massive and consists of tightly packed grains, and Type IV which is relatively massive and featureless.

However, in embodiments disclosed herein, when inorganic fiber-seeds having charged surfaces are added to the mixture of hydraulic cement and water, the charged surface thereof attracts Calcium or Silicates to grow therefrom to facilitate a more extensive formation of fibrous Type I C-S-H binders. Depending on the inorganic fiber-seed material used, as described later, in some embodiments, the inorganic fiber-seed reacts with the cement and water such that fibrous C-S-H binders form therefrom.

In other embodiments, surface reactions occur between the inorganic fiber-seeds, cement and water such that fibrous C-S-H binders form from the inorganic fiber-seeds. For example, inorganic fiber-seeds of minerals and glass based on silicates, having various cations such as calcium, sodium or potassium associated therewith for balancing the charge, are easily reacted with by the calcium or silicates in the cement at the surface of the inorganic fiber-seeds, causing fibrous C-S-H binders to grow therefrom. As a result, fibrous C-S-H binders are formed from the inorganic fiber-seeds.

A wide range of inorganic materials have charged surfaces, and may be used as fiber-seeds. For example, in some embodiments, the fiber-seeds are nano- or micro-fibers, in particular, inorganic or mineral fibers such as glass fibers, ceramic fibers, pure silica, potassium titanates, aluminum borosilicates, aluminum oxide-zirconium oxide polymers, single chain inosilicates, double chained inosilicates, aluminosilicate fibers, serpentine, amphibole, or a combination thereof.

In other embodiments, inosilicates that are chemically similar to C-S-H binders, such as inosilicates having calcium and hydroxyl groups, such as, pectolite (NaCa₂Si₃O₈(OH)), hillebrandite (Ca₂SiO₃(OH)₂), okenite (CaSi₂O₅.2H₂O), horneblende ((Ca,Na)₂₋₃(Mg,Fe,Al)₅(Al,Si)₈O₂₂(OH,F)₂), xonotlite (Ca₆Si₆O₁₇(OH)₂), tobermorite (Ca₅Si₆O₁₆(OH)₂.4H₂O or Ca₅Si₆(O,OH)₁₈.5H₂O), Al-substituted tobermorite (Ca₅Na_{0.9})(Si_{5.1}Al_{0.9}O₁₆(OH)₂).4H₂O), jennite (Ca₉Si₆O₁₈(OH)₆), foshagite (Ca₄Si₃O₉(OH)₂), or a combination thereof, are used as fiber-seeds. Those skilled in the art will appreciate that inosilicates having calcium but without hydroxyl groups, such as wollastonite (CaSiO₃), may also be considered as chemically similar to C-S-H binders and may be used as fiber-seeds.

The inorganic fiber-seeds S may have a single crystal form, such as having a generally fiber-like or linear shape. For example, xonotlite in single crystal form can be used as fiber-seeds. In an embodiment, the inorganic fiber-seeds, or the fiber-like portion thereof, has an average aspect ratio within the range of from about 2 to about 200. In another embodiment, the inorganic fiber-seeds, or the fiber-like portion thereof, has an average aspect ratio of about 10.

The inorganic fiber-seeds, or the fiber-like portion thereof, generally have a relatively short length, comparable to or shorter than a typical or average length of fibrous Type I C-S-H binders. In an embodiment, the inorganic fiber-seeds, or the fiber-like portion thereof, has an average length shorter than or equal to about 50 microns. In another embodiment, the inorganic fiber-seeds, or the fiber-like portion thereof, has an average length no larger than about 10 microns, in yet another embodiment, the inorganic fiber-seeds, or the fiber-like portion thereof, has an average length no larger than about 5 microns.

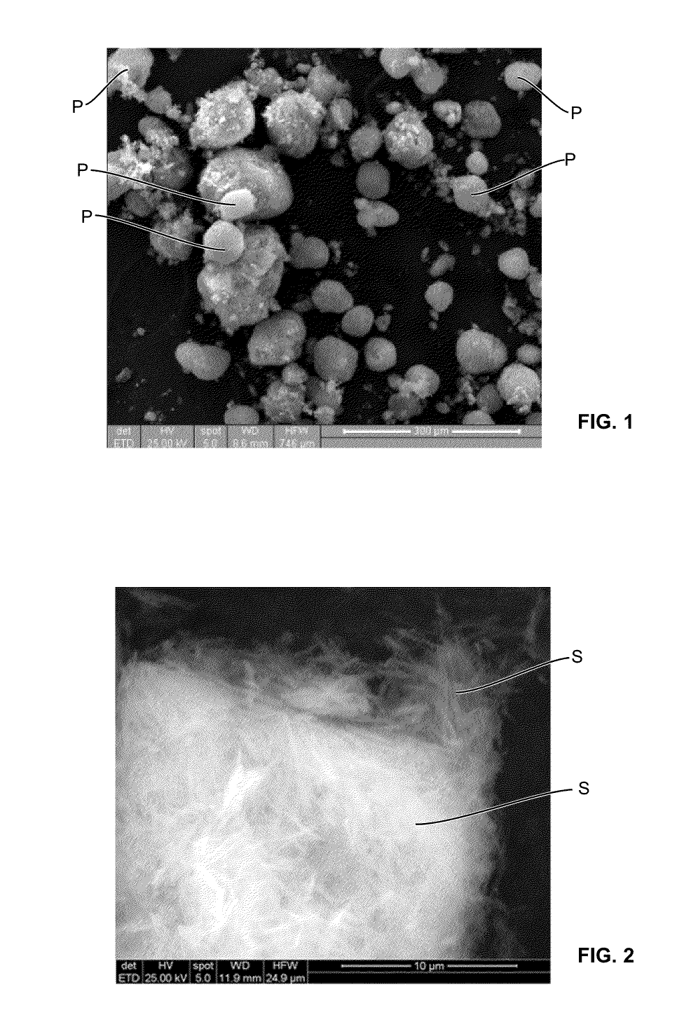

In some embodiments, the inorganic fiber-seeds can exist as separate entities, or they can be entangled for forming fine particles (see, e.g., FIGS. 1 and 2), such as, having a diameter of about 200 microns or less.

In some embodiments, the amount of the above-mentioned inorganic fiber-seeds to be added to the cement is no more than about 10% by weight of the cement (bwoc). In other embodiments, the amount of the above-mentioned inorganic fiber-seeds to be added to the cement is in the range of between about 0.5% bwoc and about 10% bwoc. In yet another embodiment, the amount of the above-mentioned fiber-seeds to be added to the cement is about 1% bwoc. In still another embodiment, the amount of the above-mentioned fiber-seeds to be added to the cement is about 5% bwoc.

Cement Slurry Having Organic Fiber-Seeds

In yet other embodiments, the fiber-seeds are a hardened organic composition having a charged surface. In one embodiment, the organic fiber-seeds comprise phenolic resin, acrylic resin, epoxy resin, styrene-vinyl ester, or a combination thereof.

In some embodiments, the organic fiber-seeds are hardened-form resin particles in various shapes including irregular shapes. In one embodiment, the size of the hardened-form resin particles ranges between about 1 micron and about 10 microns. In one embodiment, the average size of the hardened-form resin particles is about 2 microns.

In some embodiments, the organic fiber-seeds may be resinous fibers in a hardened form, having a shape at least a portion of which is fiber-like, i.e., having a large aspect ratio within a range commonly recognized as being a fiber. For example, in an embodiment, the resinous fibers, or the fiber-like portion thereof, have an average aspect ratio within the range of from about 2 to about 200. In another embodiment, the resinous fibers, or the fiber-like portion thereof, have an average aspect ratio of about 10.

In some embodiments, the resinous fibers, or the fiber-like portion thereof, generally have a relatively short length, comparable to or shorter than a typical or average length of fibrous Type I C-S-H binders. In an embodiment, the resinous fibers, or the fiber-like portion thereof, have an average length shorter than or equal to about 50 microns. In another embodiment, the resinous fibers, or the fiber-like portion thereof, have an average length no larger than about 10 microns, in yet another embodiment, the resinous fibers, or the fiber-like portion thereof, have an average length no larger than about 5 microns.

In some embodiments, the amount of the above-mentioned hardened-form resin fiber-seeds to be added to the cement is no more than about 10% bwoc. In other embodiments, the amount of the above-mentioned hardened-form resin fiber-seeds to be added to the cement is in the range of between about 0.5% bwoc and about 10% bwoc. In yet another embodiment, the amount of the above-mentioned hardened-form resin fiber-seeds to be added to the cement is about 1% bwoc. In still another embodiment, the amount of the above-mentioned hardened-form resin fiber-seeds to be added to the cement is about 5% bwoc.

Advantages of Using Fiber-Seeds

One of the advantages of using fiber-seeds for facilitating the formation of fibrous C-S-H binders is that fiber-seeds do not need to be resistant to corrosion caused by various chemical compositions in cement. Once the fibrous C-S-H binders have formed from fiber-seeds, the formed fibrous C-S-H binders provide improved strength and tensile properties. Even if the fiber-seeds are later corroded, the impact of the corrosion to the strength and tensile properties of the cement is negligible. In some instances, the C-S-H binders might also be corroded, limiting the improvement.

Fiber-Seeds in Use

In use, the inorganic or organic fiber-seeds may be mixed with dry cement such as cement powder, and water in any suitable order, with sufficient blending or mixing to allow the fiber-seeds to be generally homogeneously or uniformly distributed in the cement slurry. For example, in one embodiment, the fiber-seeds are mixed with dry cement, such as, cement powder. The mixture is sufficiently blended or mixed, and then the seeded cement is mixed with water, according to conventional mixing protocols known in the art, to form a pumpable cement slurry. The pumpable cement slurry is then pumped into the wellbore using established conventional cementing procedures and apparatus.

Alternatively, the fiber-seeds may be first mixed with water as a seeding mixture, to generate a suspension of fiber-seeds in water. The seeding mixture is then added to cement or a cement slurry, i.e., mixture of cement and water prepared according to conventional mixing protocols known in the art, to form a pumpable cement slurry. Or, the fiber-seeds may be added to a cement slurry to form a pumpable cement slurry. Sufficient blending or mixing of the pumpable cement slurry is generally required to allow the fiber-seeds to be generally homogeneously or uniformly distributed in the cement slurry. The pumpable cement slurry is then pumped into the wellbore using established conventional cementing procedures and apparatus.

The fiber-seeds alone, absent formation of fibrous C-S-H binders, are not themselves sufficient to create a cement having the characteristics of the present disclosure. It is after additional fibrous C-S-H binders have formed, due to the use of the fiber-seeds, that the strength characteristics become evident. The fiber-seeds in the cement slurry facilitate the in-situ formation of fibrous Type I C-S-H binders for forming a generally homogeneous matrix. As a large amount of fibrous C-S-H binders are formed and uniformly distributed in the set cement, the so-formed cement sheath exhibits improved mechanical properties, and resists many stresses induced during well completion processes, and over the lifetime of the well. In addition, the in-situ formation of fibrous C-S-H binders, as disclosed herein, also improves the tensile strength of the cement sheath. Compared to the existing methods of adding reinforcement fibers into the cement, such as that disclosed in the aforementioned U.S. Pat. No. 8,123,852, the method disclosed herein can achieve a more homogeneous fiber distribution in the cement sheath, and/or achieve the homogeneous fiber distribution more easily.

Cement Slurry Having Liquid Resin

In an alternative embodiment, liquid resin such as phenolic resins, acrylic resins or epoxy resins in liquid form together with hardening agents are used as the seeding additive for facilitating the formation of fibrous C-S-H binders. The hardening agents are based in polyamines, alkoxylated polyamines, heterocylic amines, or similar compounds including a plurality of amino groups. The liquid resin may also be styrene-vinyl esters and the hardening agent be organic peroxide. In this embodiment, the liquid resin is first mixed with a corresponding hardening agent to form a resin mixture. The resin mixture is then added into cement or a cement slurry and sufficiently mixed therewith to generally homogeneously or uniformly distribute the resin mixture in the cement slurry, before the resin mixture is hardened. Fiber-seeds and fibrous Type I C-S-H binders are formed in-situ with the curing of the resin in the cement slurry.

Fiber-Seeded Cement Slurry Having Other Additives

Those skilled in the art would appreciate that, in some embodiments, additives routinely added in cementing compositions, such as dispersing agents, antifoam agents, suspension agents, cement retarders or accelerating agents, and fluid loss control agents, can also be added to the fiber-seeded cement (i.e., the cement having a seeding additive as described above). For example, in some embodiments, the amount of dispersant to be added to the cement is no more than about 2% bwoc.

Those skilled in the art would also appreciate that, in yet other embodiments, the fiber-seeded cement may be further reinforced by adding conventional reinforcing fibers such as amorphous metal fibers, glass fibers, organic fibers, carbon nanofibers, that are generally of a length longer than that of the fiber-seeds and the in-situ formed fibrous Type I C-S-H binders. The reinforcement fibers may be in crystal form or in amorphous form, may or may not have charged surface; and are preferably inert.

### EXAMPLES

The following examples further illustrate the cement compositions disclosed herein. In these examples, a plurality of 600 mL cement slurry samples are prepared. Each sample is prepared by mixing API Class G cement with water according to API Recommended Practice 10B-2 (API RP 10B-2, formerly API RP 10B), entitled “Recommended Practice for Testing Well Cements,” SECOND EDITION, published by API in April 2013. Seeding additives or non-seeding additives are also added to some samples as described below.

As those skilled in the art understand, the API RP 10B-2 defines a standard procedure for weighing, mixing and blending a cement sample to form a cement slurry in a lab environment using a sample size reasonable for lab testing, to simulate the amount and rate of shear during mixing in the field, wherein the rate of shear affects cement performance. Further, API RP 10B-2 ensures consistency from lab to lab.

Essentially, API RP 10B-2 requires that the cement is added to the water instead of adding the water to the cement. API RP 10B-2 defines that the cement and dry additives are weighed, dry blended to give a uniform blend and added to the required amount of water at a uniform rate in no more than 15 seconds to make a slurry volume of approximately 600 mL in a mixing device, such as a Waring blender, at a speed of 4000 revolutions per minute (rpm). The slurry is then mixed an additional 35 seconds at 12,000 rpm. In some alternative embodiments, one may add liquid additives to the mix water prior to adding cement, which is used particularly in offshore applications, or preblend dry additives in the mix water prior to adding cement.

According to API RP 10B-2, the 4000 rpm rotation during addition of the cement powder into the water is the highest shear that allows the cement and water to mix together. After the cement has mixed into the water, the 35-second 12,000 rpm rotation, together with the previous 15-second 4000 rpm rotation, results in a shear rate equivalent to that typically obtained in the field.

According to API RP 10B-2, cement mixing is conducted at temperatures representative of the above-ground temperature in the field, or at 23° C.±1° C. if the above-ground temperature in the field is unknown. Practically, cement mixing is conducted at room temperature in most cases. After cement mixing, testing can be conducted at various temperatures and pressures in accordance with test design and expected well conditions.

### Example 1

### In-Situ Fibrous C-S-H Binder Formation

In this example, three samples of set cement were obtained according to API RP 10B-2 by first preparing three 600 mL slurries of API Class G cement with or without the addition of seeding or non-seeding additives as described below. The samples were then cured at 25° C. in a water bath for three (3) days. Thereafter, C-S-H binder formation was analyzed in each sample.

The first sample comprised only the API Class G cement mixed with water according to API RP 10B-2. No additive was added therein.

The second sample was prepared by first dry-blending API Class G cement with 1% bwoc carbon nano-tubes, which was then mixed with water according to API RP 10B-2.

The third sample was prepared by first dry blending API Class G cement with 1% bwoc xonotlite, which was then mixed with water according to API RP 10B-2.

After the samples were hardened, fragments of each hardened sample were placed in a JEOL JSM-6610 Scanning Electron Microscope (SEM), manufactured by JEOL Ltd. of Tokyo, Japan, to analyze their microstructure.

Having reference to FIGS. 1 and 2, the xonotlite particles P having fiber-seeds S used for preparing the third sample are generally spherical particles composed of many small xonotlite fibers when viewed under an SEM at different magnification levels. The images were captured using a JEOL JSM-6610 SEM. As illustrated in FIG. 1, the diameters of xonotlite particles P range from about 200 microns to less than about 10 microns.

As illustrated in FIG. 2, which is a magnified image of the surface of a spherical xonotlite particle P, the xonotlite particles are composed of many individual fibers S coalesced together. Referring to the scale legend in the lower, right corner of FIG. 2, it can be seen that the lengths of the fibers S are equal to or less than about 5 microns, and the widths thereof are equal to or less than about 0.5 micron, giving rise to an aspect ratio of about 10.

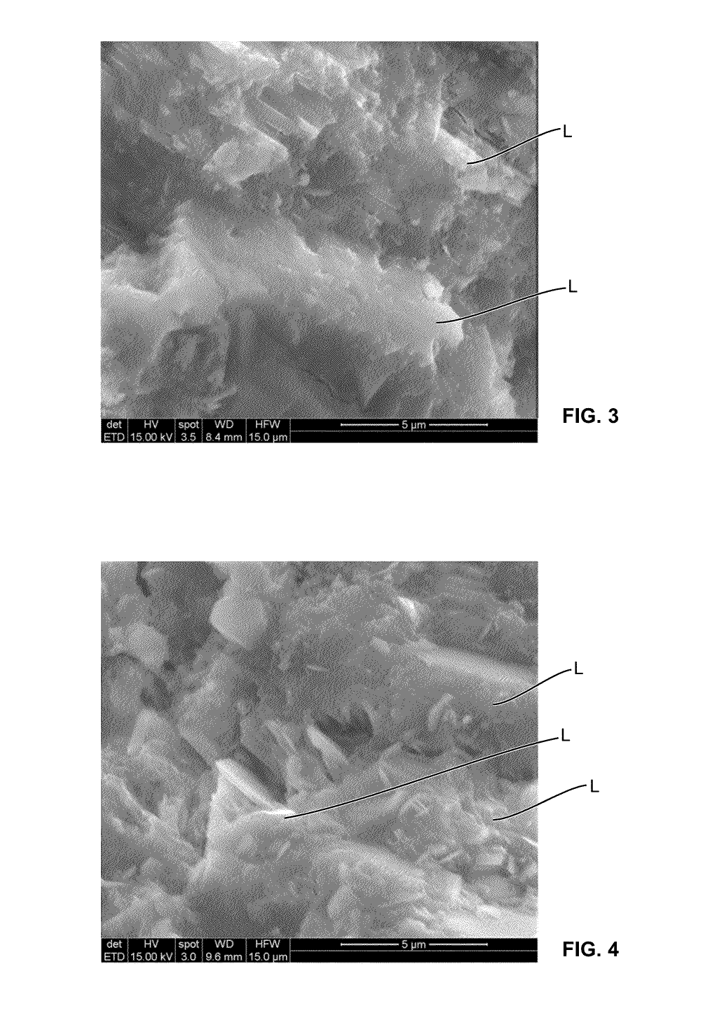

FIG. 3 is an SEM image of the first sample having no additive. As can be seen, the principal hydration product in the set cement is a featureless Type IV C-S-H binders L.

FIG. 4 is an SEM image of the second sample with addition of carbon nano-tubes. The principal hydration product in the set cement is featureless Type IV C-S-H binders L, not fibrous C-S-H binders, which the Applicant believes because carbon nano-tubes do not have a charged surface,

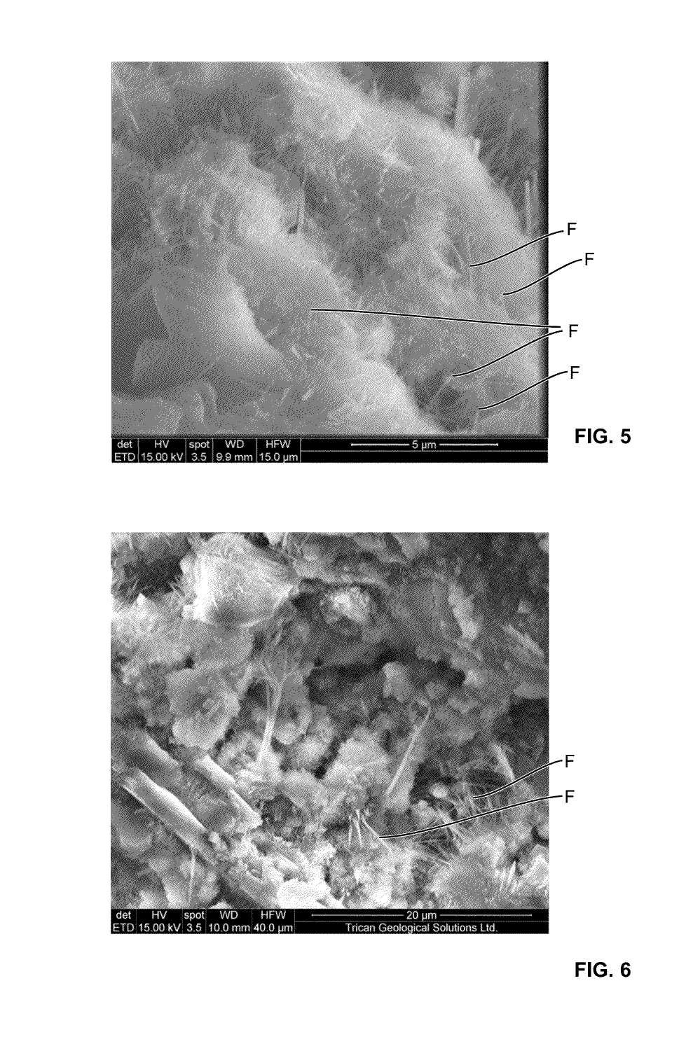

FIG. 5 is an SEM image of the third sample with addition of xonotlite particles as fiber-seeds (as in FIGS. 1 and 2), according to an embodiment described herein. As can be seen, the principal hydration product in the set cement is fibrous Type I C-S-H binders F, which is suitable to improve the strength and tensile properties of the cement.

### Example 2

### In-Situ Fibrous C-S-H Binder Formation Using Xonotlite and Wollastonite as Fiber-Seeds

In this example, two samples of set cement were obtained according to API RP 10B-2 by first preparing two 600 mL slurries of API Class G cement with the addition of seeding additives xonotlite and wollastonite as described below. The samples were then cured at 25° C. for seven (7) days with one day under a pressure of 10.4 MPa, and six (6) days in atmospheric pressure water bath. Thereafter, C-S-H binder formation was analyzed in each sample.

The first sample was prepared by first dry-blending API Class G cement with 1% bwoc xonotlite, which was then mixed with water according to API RP 10B-2.

The second sample was prepared by first dry-blending API Class G cement with 1% bwoc wollastonite, which was then mixed with water according to API RP 10B-2.

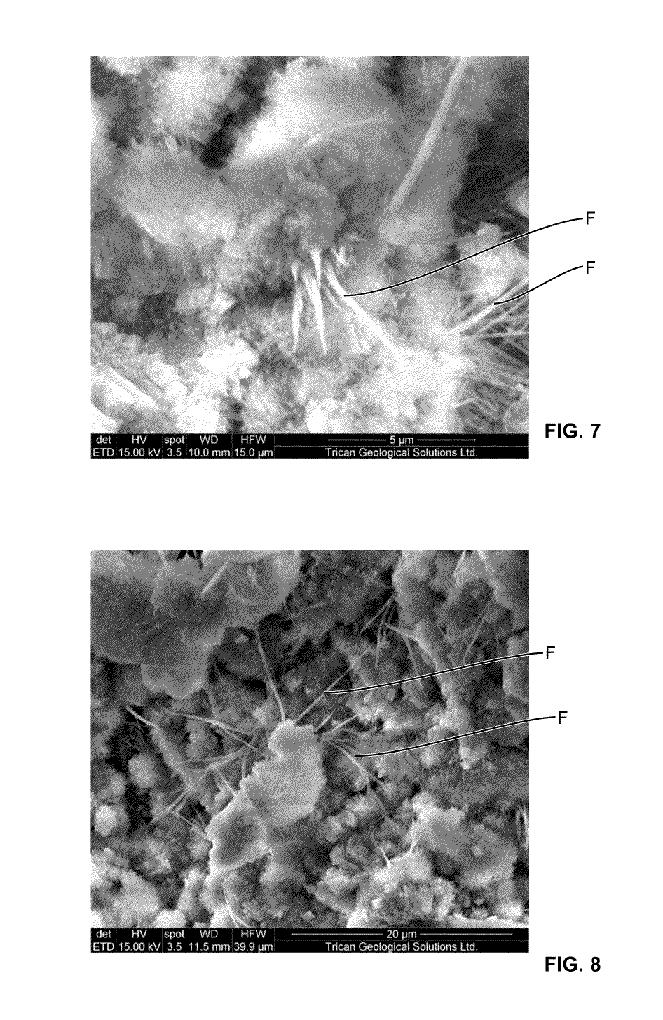

FIG. 6 is an SEM image of the first sample with addition of xonotlite as fiber-seeds. FIG. 7 is an SEM image of the same sample at a higher resolution. As can be seen, the principal hydration product in the set cement is fibrous Type I C-S-H binders F, which is suitable to improve the strength and tensile properties of the cement.

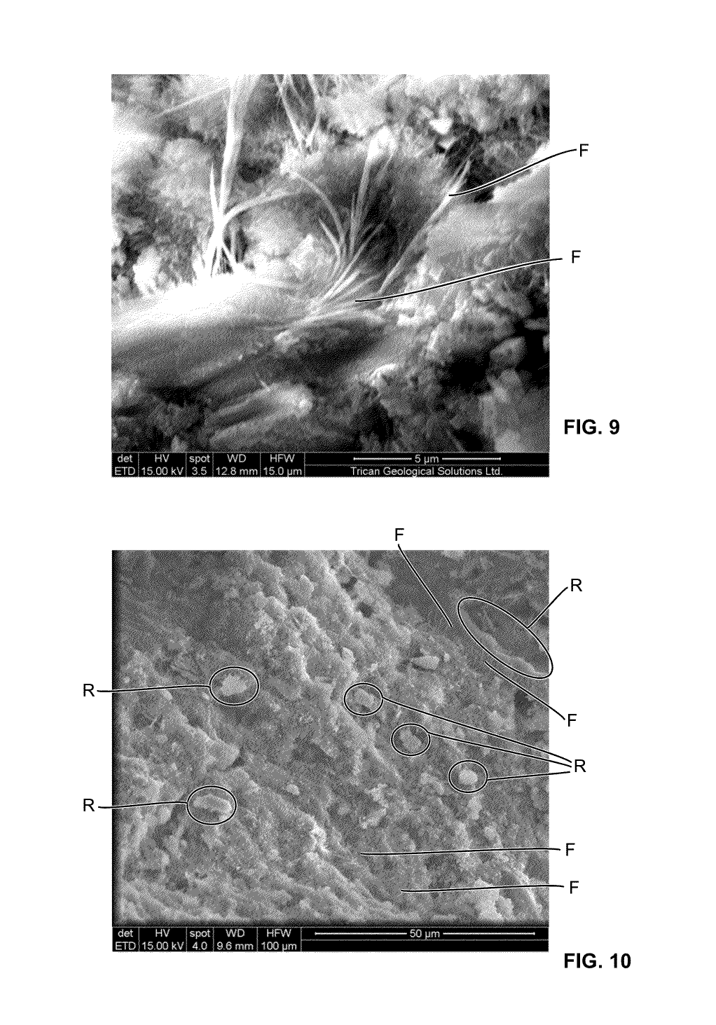

FIG. 8 is an SEM image of the second sample with addition of wollastonite as fiber-seeds. FIG. 9 is an SEM image of the same sample at a higher resolution. As can be seen, the principal hydration product in the set cement is fibrous Type I C-S-H binders F, which is suitable to improve the strength and tensile properties of the cement.

### Example 3

### In-Situ Fibrous C-S-H Binder Formation Using Liquid-Form Resin

A sample of set cement was prepared from 600 mL cement/resin slurry consisting of 450 mL Class G non-seeded cement slurry (i.e., cement slurry without any seeding additives) and 150 mL resin liquid, cured at 52° C. in a water bath. Thus, the non-seeded cement slurry and the resin liquid are mixed in a volume ratio of about 3:1. To prepare the 600 mL cement/resin slurry, 150 mL of resin liquid was first prepared by hand-mixing a liquid-form of phenolic resin and a suitable hardening agent in a 100:30 ratio by weight, for 30 minutes. A 450 mL cement slurry was prepared by mixing Class G cement with water according to API RP 10B-2. The cement slurry was further mixed for 3 minutes at 2500 rpm during which time the 150 mL liquid resin was added therein by syringe.

Once set, fragments of the set sample were viewed under a JEOL JSM-6610 SEM to analyze the microstructure. FIG. 10 is an annotated SEM image which shows the formation of resin fibers R which are circled on the image for clarity, and fibrous Type 1 C-S-H binders F as indicated therein by arrows.

Although in this example the resin liquid is mixed for 30 minutes prior to being added into cement slurry, Applicant has observed that the liquid resin can be mixed for 60 or 120 minutes prior to addition to the cement slurry.

### Example 4

### In-Situ Fibrous C-S-H Binder Formation Using Hardened-Form Resin as Fiber-Seeds

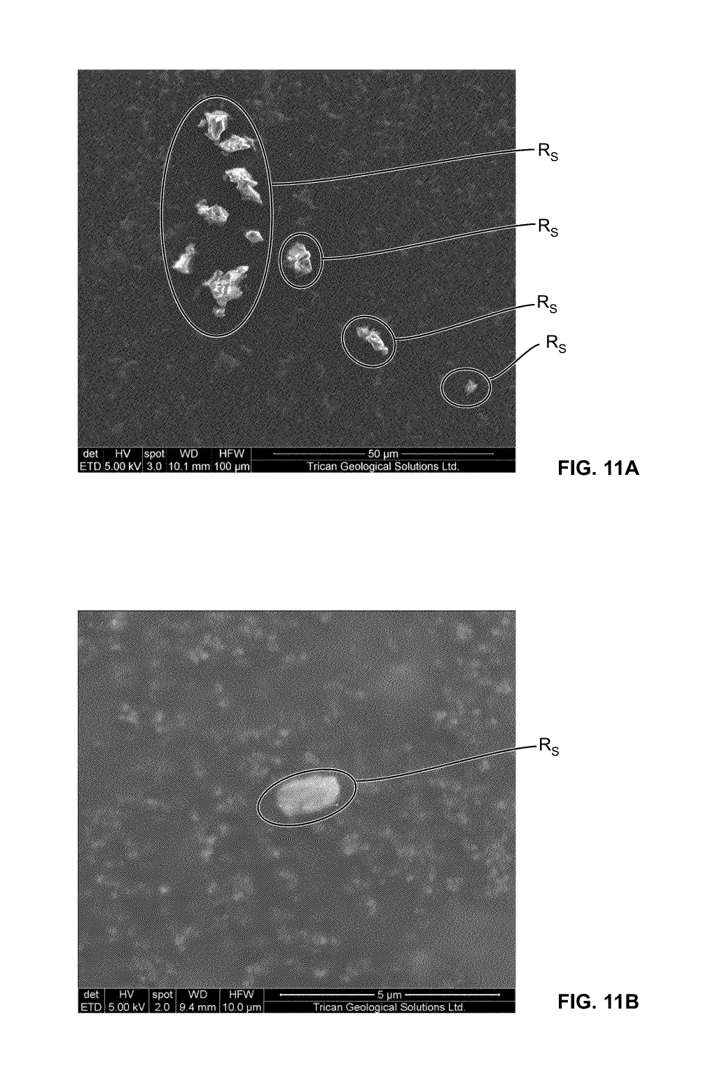

In this example, a sample was prepared by first dry-blending API Class G cement with 1% bwoc hardened-form resin. The hardened-form resin comprised particles having various sizes, with an average particle size of 2 microns. FIGS. 11A and 11B are SEM images of some large-size and small-size resin particles Rs, respectively. As can be seen, the resin particles Rs have generally irregular shapes.

The cement/resin mixture was then mixed with water according to API RP 10B-2 to obtain a 600 mL slurry of API Class G cement. The samples were then cured at 25° C. for three (3) days in an atmospheric pressure water bath. Thereafter, C-S-H binder formation was analyzed by SEM.

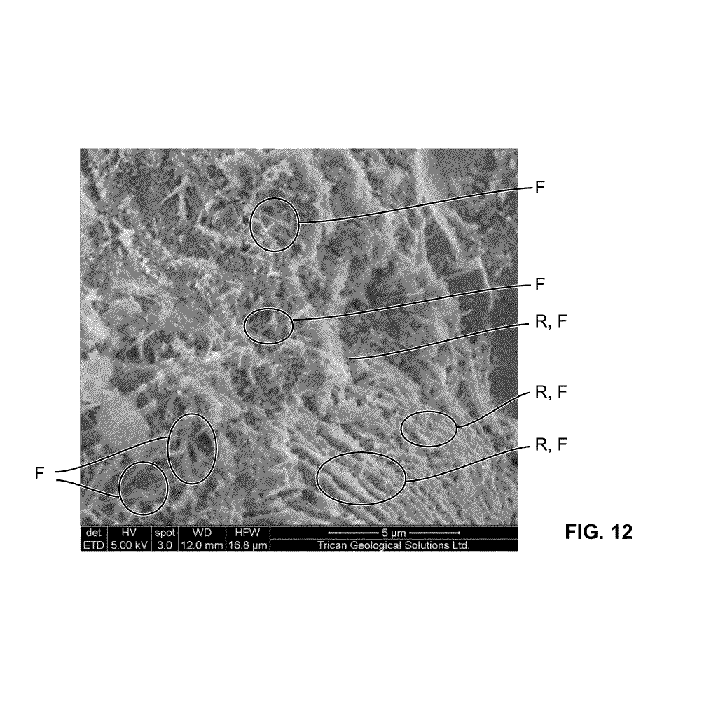

Once set, fragments of the set sample were viewed under a JEOL JSM-6610 SEM to analyze the microstructure. FIG. 12 is an annotated SEM image. Evident from the image, the set cement comprises a large amount of fibrous Type I C-S-H binders F and hardened-form resin R with fibrous Type I C-S-H binders F on the surface thereof. As can be seen, the fibrous Type I C-S-H binders F are distributed generally homogeneously in the set cement sample, and are the principal hydration product in the set cement suitable to improve the strength and tensile properties of the cement.

### Example 5

### Tensile Strength Measurement

Four set cement samples as described below were prepared as in examples 1 and 3, and placed in dogbone shaped briquette molds according to ASTM C307, entitled “Standard Test Method for Tensile Strength of Chemical-Resistant Mortar, Grouts, and Monolithic Surfacings”, published by ASTM International in August 2012, the content of which is incorporated herein by reference in its entirety. The briquettes were then cured in a water bath. Tensile strength of each cured briquette was then measured according to ASTM C307 using an ADMET 2611 Dual Column Universal Test Machine, manufactured by ADMET, Inc. of Norwood, Mass., USA.

A 600 mL amount of sample No. 1 (prior art) was prepared using Class G cement without additive mixed with water according to API RP 10B-2, and cured at 25° C. in a water bath.

A 600 mL amount of sample No. 2 was prepared using dry-mixed Class G cement and 1% bwoc xonotlite mixed with water according to API RP 10B-2, and cured at 25° C. in a water bath.

A 600 mL amount of sample No. 3 (prior art) was prepared using Class G cement without additive mixed with water according to API RP 10B-2, and cured at 52° C. in a water bath.

A 600 mL amount of sample No. 4 was prepared by mixing 450 mL Class G cement slurry prepared according to API RP 10B-2 with 150 mL resin liquid consisting of phenolic resin and a suitable hardening agent in a ratio of 100:30 which had been premixed for 30 minutes. Sample No. 4 was cured at 52° C. in a water bath.

The test results are shown in Table 1, where “-” means that no xonotlite or resin was added. As can be seen, sample Nos. 2 and 4, containing in-situ formed fibrous C-S-H binders, exhibit higher tensile strength than sample Nos. 1 and 3 having no additives.

TABLE 1
Tensile Strength Testing Results

| | Temp | Class G | Xonotlite | Resin | Tensile |
|---|---|---|---|---|---|
| Sample No. | (° C.) | Cement (g) | (g) | (mL) | strength (psi) |
| 1 (prior art) | 25 | 792 | — | — | 526 |
| 2 | 25 | 792 | 7.92 | — | 597 |
| 3 (prior art) | 52 | 792 | — | — | 313 |
| 4 | 52 | 594 | — | 150 | 422 |

### Example 6

### Tensile Strength Measurement

In this example, six samples of set cement were obtained according to API RP 10B-2, 1st Edition, 2005, of the American Petroleum Institute for Preparation of Slurry. In preparing these samples, the amount of water added in all cases was such to give a slurry density of 1901 kgm⁻³.

The first sample was prepared by first dry blending 1% bwoc wollastonite with API Class G cement, and then adding this blend to water. The slurry is then conditioned in an atmospheric consistometer at 25° C. for 20 minutes.

The second sample was prepared by first dry blending 1% bwoc xonotlite with API Class G cement, and then adding this blend to water. The slurry is then conditioned in an atmospheric consistometer at 25° C. for 20 minutes.

The third, fourth and fifth samples were prepared by preblending 0.03% bwoc, 0.05% bwoc and 0.1% bwoc carbon nano-tubes, respectively, in the water prior to adding the cement.

The sixth sample comprises only the API Class G cement mixed with water. No additive was added therein.

The slurry after conditioning was then placed in molds designed for tensile testing according to ASTM C307-03, 2008, Standard Test Method for Tensile Strength of Chemical Resistant Mortar, Grouts and Monolithic Surfacings, and cured for 24 hours at 10.3 MPa and 25° C., demolded and cured for a further 6 days at atmospheric pressure in a water bath at 25° C. The tensile strength was determined according to ASTM C307-03, 2008.

The test results are shown in Table 2, where “-” means that no additives were added. As the test of this example was conducted in a lab different from that of the test of Example 4, the obtained tensile strength values in Table 2 are not exactly same as those in Table 1.

As can be seen, sample Nos. 1 and 2, cements with wollastonite and xonotlite seed fibers, which contain in-situ formed fibrous C-S-H binders after setting, exhibit higher tensile strength than sample No. 6 having no additives. Samples Nos. 3 to 5, cements with carbon nano-tubes, exhibit lower tensile strength than sample No. 6 having no additives.

TABLE 2
Tensile strength Testing Results

| Sample | | | Tensile | Tensile |
|---|---|---|---|---|
| No. | Additive | % BWOC | strength (Psi) | strength (MPa) |
| 1 | Wollastonite | 1 | 431 | 2.97 |
| 2 | Xonotlite | 1 | 438 | 3.02 |
| 3 | Carbon nano-tubes | 0.03 | 386 | 2.66 |
| 4 | Carbon nano-tubes | 0.05 | 387 | 2.67 |
| 5 | Carbon nano-tubes | 0.1 | 381 | 2.62 |
| 6 | — | — | 399 | 2.75 |

### Example 7

### Thickening Time Measurement

In this example, the effect of fiber-seeds on thickening time, when dispersant and/or retarder is added to the cement slurry, is compared.

Seven samples of set cement were obtained and tested according to API RP 10B-2, 1st Edition, 2005, of the American Petroleum Institute for Well-Simulation Thickening-Time Tests. In preparing these samples, the amount of water added was such to give a slurry density of 1901 kgm⁻³.

The first sample was prepared by first dry blending API Class G cement with 1% bwoc wollastonite, which was then added to water.

The second sample was prepared by first dry blending API Class G cement with 5% bwoc wollastonite as fiber-seeds and 0.5% bwoc sulfonated polynaphthalene-formaldehyde as dispersant, which was then added to water.

The third sample was prepared by first dry blending API Class G cement with 5% bwoc wollastonite as fiber-seeds, 0.5% bwoc sulfonated polynaphthalene-formaldehyde as dispersant and 0.3% bwoc lignosulfonate as retarder, which was then added to water.

The fourth sample was prepared by first dry blending API Class G cement with 1% bwoc xonotlite, which was then added to water.

The fifth sample was prepared by first dry blending API Class G cement with 5% bwoc xonotlite as fiber-seeds and 1% bwoc sulfonated acetone-formaldehyde condensate as dispersant, which was then added to water.

The sixth sample was prepared by first dry blending API Class G cement with 5% bwoc xonotlite as fiber-seeds, 1% bwoc sulfonated acetone-formaldehyde condensate as dispersant and 0.3% bwoc lignosulfonate as retarder, which was then added to water.

The seventh sample comprises only the API Class G cement mixed with water. No additive was added therein.

Each of the samples was poured into a slurry cup assembly and placed into a test cell of a high-temperature-high pressure consistometer and heated from ambient temperature to 52° C. in 8 minutes. The slurry container was rotated at 150 RPM. The amount of torque the slurry exerts on an API-approved paddle is measured to determine the Bearden Unit of Consistency (Bc) of each sample. In this example, the thickening times to 40Bc and 100Bc are respectively recorded for each sample. Generally, cement slurry of 70Bc or lower is considered as suitable for pumping into wellbores.

The test results are shown in Table 3, where “-” means that no fiber-seeds, dispersant or retarder was added. As can be seen, thickening time is accelerated by the addition of seed fibers compared to neat cement slurry, i.e., cement slurry without any additives, but can be controlled by addition of an appropriate retarder.

TABLE 3
Thickening Time Testing Results

| | | | | | Thickening Time | |
|---|---|---|---|---|---|---|
| Sample | | | | Temp | (Hours: minutes) | |
| No. | Fiber-Seeds | Dispersant | Retarder | (° C.) | 40 Bc | 100 Bc |
| 1 | 1% bwoc | — | — | 52 | 1:02 | 1:41 |
| | wollastonite | | | | | |
| 2 | 5% bwoc | 0.5% | — | 52 | 0:55 | 1:16 |
| | wollastonite | bwoc D1 | | | | |
| 3 | 5% bwoc | 0.5% | 0.3% bwoc | 52 | 2:42 | 3:02 |
| | wollastonite | bwoc D1 | R | | | |
| 4 | 1% bwoc | — | — | 52 | 0:45 | 1:09 |
| | xonotlite | | | | | |
| 5 | 5% bwoc | 1% bwoc | — | 52 | 0:38 | 0:44 |
| | xonotlite | D2 | | | | |
| 6 | 5% bwoc | 1% bwoc | 0.3% bwoc | 52 | 1:11 | 1:20 |
| | xonotlite | D2 | R | | | |
| 7 | — | — | — | 52 | 1:10 | 1:39 |

D1: sulfonated polynaphthalene-formaldehyde condensate
D2: sulfonated acetone-formaldehyde condensate
R: lignosulfonate

### Example 8

### Compressive Strength Measurement

In this example, the effect of fiber-seeds on compressive strength of set cement is compared.

Five samples of set cement were obtained and tested according to API RP 10B-2, 1st Edition, 2005, of the American Petroleum Institute for Non-destructive sonic testing of cement. In preparing these samples, the amount of water added was such to give a slurry density of 1901 kgm⁻³.

The first sample was prepared by first dry blending API Class G cement with 1% bwoc wollastonite, which was then mixed with water according to API RP 10B-2.

The second sample was prepared by first dry blending API Class G cement with 5% bwoc wollastonite as fiber-seeds and 0.5% bwoc sulfonated polynaphthalene-formaldehyde as dispersant, which was then mixed with water according to API RP 10B-2.

The third sample was prepared by first dry blending API Class G cement with 1% bwoc xonotlite, which was then mixed with water according to API RP 10B-2.

The fourth sample was prepared by first dry blending API Class G cement with 5% bwoc xonotlite as fiberseeds and 1 bwoc sulfonated acetone-formaldehyde condensate as dispersant, which was then mixed with water according to API RP 10B-2.

The fifth sample comprises only the API Class G cement mixed with water. No additive was added therein.

Each slurry after conditioning was then placed in the test cell of a non-destructive Ultrasonic Cement and heated from ambient temperature to 52° C. in 8 minutes, and then the compressive strength was measured.

The test results are shown in Table 4, where “-” represents no fiber-seeds or dispersant being added. Table 4 shows, for each sample, the time in (hours: minutes) format for attaining 3.4 MPa compressive strength (the fourth column), and the compressive strength measurements after 8, 12, 24 and 48 hours, respectively (the fifth to eighth columns). As can be seen, addition of fiber-seeds increases the compressive strength of cement as compared to cement without fiber-seeds.

TABLE 4
Compressive Strength Testing Results

| Sample | Fiber- | | Temp | Compressive Strength (MPa) | | | | |
|---|---|---|---|---|---|---|---|---|
| No. | Seeds | Dispersant | (° C.) | 3.5 MPa | 8 Hrs | 12 Hrs | 24 Hrs | 48 Hrs |
| 1 | 1% bwoc | — | 52 | 3:59 | 8.6 | 11.4 | 16.7 | 21.1 |
| | wollastonite | | | | | | | |
| 2 | 5% bwoc | 0.5% | 52 | 5:08 | 8.0 | 11.6 | 17.4 | 23.0 |
| | wollastonite | bwoc D1 | | | | | | |
| 3 | 1% bwoc | — | 52 | 3:39 | 9.1 | 11.7 | 16.9 | 21.3 |
| | xonotlite | | | | | | | |
| 4 | 5% bwoc | 1% bwoc | 52 | 3:18 | 9.0 | 12.0 | 17.2 | 21.4 |
| | xonotlite | D2 | | | | | | |
| 5 | — | — | 52 | 4:10 | 7.7 | 10.1 | 14.5 | 18.3 |

D1: sulfonated polynaphthalene-formaldehyde condensate
D2: sulfonated acetone-formaldehyde condensate

### Example 9

### The Effect of In-Situ Fibers on Theology and Free Water

In this example, the effect of fiber-seeds on the viscosity of cement slurry is assessed. Twelve samples of set cement were obtained and Rheology testing was conducted according to API RP 10B-2, 1st Edition, 2005, of the American Petroleum Institute for Determination of Rheological Properties and Gel Strength Using a Rotational Viscometer. In preparing these samples, the amount of water added was such to give a slurry density of 1901 kgm⁻³.

Samples 1A and 1B were each prepared by first dry blending API Class G cement with 1% bwoc wollastonite, which was then added to water. Then, samples 1A and 1B were conditioned in an atmospheric consistometer at 25° C. and 52° C., respectively, for 20 minutes.

Samples 2A and 2B were each prepared by first dry blending API Class G cement with 5% bwoc wollastonite as fiber-seeds and 0.5% bwoc sulfonated polynaphthalene-formaldehyde as dispersant, which was then added to water. Then, samples 2A and 2B were conditioned in an atmospheric consistometer at 25° C. and 52° C., respectively, for 20 minutes.

Samples 3A and 3B were each prepared by first dry blending API Class G cement with 1% bwoc xonotlite, which was then added to water. Then, samples 3A and 3B were conditioned in an atmospheric consistometer at 25° C. and 52° C., respectively, for 20 minutes.

Samples 4A and 4B were made with the 1% xonotlite pre-hydrated in mixing water before the cement was added. Then, samples 4A and 4B were conditioned in an atmospheric consistometer at 25° C. and 52° C., respectively, for 20 minutes.

Samples 5A and 5B were each prepared by first dry blending API Class G cement with 5% bwoc xonotlite as fiber-seeds and 1% bwoc sulfonated acetone-formaldehyde condensate as dispersant, which was then added to water. Then, samples 5A and 5B were conditioned in an atmospheric consistometer at 25° C. and 52° C., respectively, for 20 minutes.

Samples 6A and 6B were each prepared by mixing API Class G cement with water. No additive was added therein. Then, samples 6A and 6B were conditioned in an atmospheric consistometer at 25° C. and 52° C., respectively, for 20 minutes.

Each slurry after conditioning was then placed in the rheometer cell for rheology test. The test results are shown in Tables 5-1 and 5-2, where “-” means that no fiber-seeds or dispersant was added.

Free fluid was determined according to API Specification RP 10B-2, 1st Edition, 2005, of the American Petroleum Institute for Well-Simulation Slurry Stability Tests. Samples 1B, 2B, 3B, 5B and 6B were re-prepared for free fluid test. Each of the slurries after conditioning was then placed in a 250 mL graduated tube, covered to prevent evaporation and placed in a water bath at 52° C. under essentially vibration free conditions. The % of free water was calculated as given in the standard procedure. The test result is shown in Table 5-3, where “-” means that no fiber-seeds or dispersant was added.

As can be seen, the addition of the fiber-seeds increases the apparent viscosity of the slurry in comparison to the neat cement and decreases the yield value. Tables 5-1 to 5-3 show that the slurries with fiber-seeds have good rheologies and can be pumped in oil and gas wells. Slurries are stable with virtually no free water or particle sedimentation.

TABLE 5-1
Rheology Testing Results

| | | | | Rheology (Dial Reading) | | | | |
|---|---|---|---|---|---|---|---|---|
| | | | Temp | 300 | 200 | 100 | 6 | 3 |
| Sample No. | Fiber-Seeds | Dispersant | (° C.) | (rpm) | (rpm) | (rpm) | (rpm) | (rpm) |
| 1A | 1% bwoc | — | 25 | 75 | 62 | 50 | 18 | 10 |
| 1B | wollastonite | | 52 | 94 | 83 | 69 | 17 | 10 |
| 2A | 5% bwoc | 0.5% bwoc | 25 | 129 | 107 | 78 | 26 | 17 |
| 2B | wollastonite | D1 | 52 | 65 | 50 | 38 | 11 | 8 |
| 3A | 1% bwoc | — | 25 | 130 | 115 | 94 | 31 | 20 |
| 3B | xonotlite | | 52 | 157 | 141 | 120 | 23 | 18 |
| 4A | 1% bwoc xonotlite/ | — | 25 | 139 | 124 | 105 | 32 | 19 |
| 4B | pre-hydrated | | 52 | 156 | 143 | 124 | 35 | 24 |
| 5A | 5% bwoc | 1% bwoc | 25 | 113 | 76 | 39 | 4 | 2 |
| 5B | xonotlite | D2 | 52 | 95 | 61 | 33 | 6 | 4 |
| 6A | — | — | 25 | 58 | 49 | 39 | 21 | 11 |
| 6B | | | 52 | 76 | 67 | 56 | 19 | 10 |

D1: sulfonated polynaphthalene-formaldehyde condensate
D2: sulfonated acetone-formaldehyde condensate

TABLE 5-2
Rheology Testing Results

| | | | | Plastic | Yield |
|---|---|---|---|---|---|
| Sample | | | Temp | Viscosity | Point |
| No. | Fiber-Seeds | Dispersant | (° C.) | (Pa) | (cP) |
| 1A | 1% bwoc | — | 25 | 37.5 | 18.0 |
| 1B | wollastonite | | 52 | 37.5 | 27.0 |
| 2A | 5% bwoc | 0.5% bwoc | 25 | 76.5 | 25.1 |
| 2B | wollastonite | D1 | 52 | 40.5 | 11.7 |
| 3A | 1% bwoc xonotlite | — | 25 | 54.0 | 36.4 |
| 3B | | | 52 | 55.5 | 48.6 |
| 4A | 1% bwoc xonotlite/ | — | 25 | 51 | 42.1 |
| 4B | pre-hydrated | | 52 | 48 | 51.7 |
| 5A | 5% bwoc xonotlite | 1% bwoc | 25 | 111.0 | 0.9 |
| 5B | | D2 | 52 | 93.0 | 0.9 |
| 6A | — | — | 25 | 28.5 | 14.1 |
| 6B | | | 52 | 30.0 | 22.0 |

D1: sulfonated polynaphthalene-formaldehyde condensate
D2: sulfonated acetone-formaldehyde condensate

TABLE 5-3
Rheology Testing Results

| | | | | Free |
|---|---|---|---|---|
| | | | Temp | fluid |
| Sample No. | Fiber-Seeds | Dispersant | (° C.) | (%) |
| 1B | 1% bwoc wollastonite | — | 52 | 0 |
| 2B | 5% bwoc wollastonite | 0.5% bwoc | 52 | 0.92 |
| | | D1 | | |
| 3B | 1% bwoc xonotlite | — | 52 | 0 |
| 5B | 5% bwoc xonotlite | 1% bwoc | 52 | 0 |
| | | D2 | | |
| 6B | — | — | 52 | 0 |

D1: sulfonated polynaphthalene-formaldehyde condensate
D2: sulfonated acetone-formaldehyde condensate

Although embodiments have been described above with reference to the accompanying drawings, those of skill in the art will appreciate that variations and modifications may be made without departing from the scope thereof.

What is claimed is:

1. A method for promoting growth of fibrous calcium silicate hydrates (C-S-H) binders throughout a wellbore cementing composition comprising:
combining cement, water and a seeding additive to form a seeded slurry, the seeding additive having a charged surface, and forming seeding sites distributed homogeneously in the seeded slurry for promoting growth of fibrous C-S-H binders therein.

2. The method of claim 1 wherein the seeding additive is solid-form fiber-seeds, and wherein the fiber-seeds have a shape at least a portion of which is a fiber-like shape.

3. The method of claim 1 wherein the seeding additive comprises inorganic fibers having a charged surface.

4. The method of claim 1 wherein the seeding additive comprises at least one of single chain inosilicates and double chain inosilicates.

5. The method of claim 1 wherein the seeding additive comprises an organic composition.

6. The method of claim 1 wherein the seeding additive comprises resin in at least one of a hardened form and a liquid form.

7. A seeded slurry for cementing a wellbore comprising:
cement;
water; and
a seeding additive, the seeding additive having a charged surface, and forming seeding sites distributed generally homogeneously in the seeded slurry for promoting growth of fibrous C-S-H binders throughout.

8. The seeded slurry of claim 7 wherein the seeding additive is solid-form fiber-seeds, and wherein the fiber-seeds have a shape at least a portion of which is a fiber-like shape.

9. The seeded slurry of claim 8 wherein the at least a portion of the shape has an average aspect ratio between about 2 and about 200.

10. The seeded slurry of claim 8 wherein the at least a portion of the shape has an average length comparable to the average length of fibrous Type I C-S-H binders.

11. The seeded slurry of claim 7 wherein the fiber-seeds comprise inorganic fibers.

12. The seeded slurry of claim 7 wherein the fiber-seeds comprise at least one of single chain inosilicates and double chain inosilicates.

13. The seeded slurry of claim 7 wherein the fiber-seeds comprise pectolite, hillebrandite, okenite, wollastonite, horneblende, xonotlite, tobermorite, jennite, foshagite, or a combination thereof.

14. The seeded slurry of claim 7 wherein the fiber-seeds comprise pure silica, potassium titanate, aluminum borosilicate, aluminum oxide-zirconium oxide polymer, aluminosilicate fiber, serpentine, amphibole, or a combination thereof.

15. The seeded slurry of claim 7 wherein the fiber-seeds comprise glass fibers.

16. The seeded slurry of claim 7 wherein the seeding additive comprises an organic composition.

17. The seeded slurry of claim 7 wherein the amount of the seeding additive is no more than about 10% by weight of the cement (bwoc).

18. The seeded slurry of claim 7 wherein the seeding additive comprises resin in at least one of a hardened form and a liquid form.

19. The seeded slurry of claim 7 wherein the seeding additive comprises resin in a liquid form, and wherein the resin in a liquid form and the mixture of cement and water are mixed in a volume ratio of about 1:3.

20. The seeded slurry of claim 18 wherein said resin is phenolic resin, acrylic resin, epoxy resin, styrene-vinyl ester, or a combination thereof.

21. A cement mixture for cementing a wellbore comprising:
cement; and
a seeding additive homogeneously distributed in the cement, the seeding additive having a charged surface.

22. The cement mixture of claim 21 wherein the seeding additive comprises inorganic fibers.

23. The cement mixture of claim 21 wherein the seeding additive comprises an organic composition.

24. The cement mixture of claim 21 wherein the seeding additive comprises resin in at least one of a hardened form and a liquid form.

25. The cement mixture of claim 24 wherein said resin is phenolic resin, acrylic resin, epoxy resin, styrene-vinyl ester, or a combination thereof.
